(19) United States
(12) Patent Application Publication
(10) Pub. No.: US 2011/0227694 A1
(43) Pub. Date: Sep. 22, 2011

(54) CATHETER INTERFACING

(75) Inventors: Oliver Lips, Hamburg (DE); Bernd David, Huettblek (DE); Paul Haaker, Hamburg (DE); Sascha Krueger, Hamburg (DE); Steffen Weiss, Hamburg (DE); Daniel Wirtz, Hamburg (DE)

(73) Assignee: KONINKLIJKE PHILIPS ELECTRONICS N.V., EINDHOVEN (NL)

(21) Appl. No.: 13/130,369

(22) PCT Filed: Nov. 18, 2009
(86) PCT No.: PCT/IB2009/055141

§ 371 Date: May 20, 2011

(30) Foreign Application Priority Data
Nov. 24, 2008 (EP) 08169735.1

(51) Int. Cl. G05B 23/02

(52) U.S. Cl. 340/3.1

(57) ABSTRACT

The present invention relates to a device (100) and method for interfacing a signal transmission/reception device (200) and a catheter (300). A signal transmitted by the signal transmission/reception device (200) and supplied to the device (100) via a first interface (102, 104, 106, 108) can be sensed by a first sensor (114). The sensed signal may be adjusted by an adjustment unit (116). The adjusted signal can be output via a second interface (110, 112) and supplied to the catheter (300). In this way, a resistance loss caused by a conductor (302, 304) of the catheter (300) may be compensated for.

### FIELD OF THE INVENTION

The present invention generally relates to interfacing a signal transmission/reception device and a catheter. In particular, it relates to interfacing an electrophysiologic equipment and a catheter comprising highly resistive leads.

### BACKGROUND OF THE INVENTION

In EP procedures, the intracardiac electrocardiogram (IECG) is monitored (“mapping”) and/or the heart of a patient is stimulated (“pacing”). In the past, electrophysiologic (EP) interventions could not be performed safely under magnetic resonance (MR) guidance, due to the risk of MR-induced radio frequency (RF) heating.

In WO 2008/032249 A2 it has been proposed to use highly resistive wires inside an EP catheter to overcome this safety problem, i.e. to safely measure the IECG under MR. Whereas the mapping can still be performed on standard EP equipment using highly resistive wires, the pacing poses problems. That is, in principle such wires can also be used for the stimulation of the heart, but then much higher voltages are needed to achieve sufficient pacing currents, due to the high resistance of the wires. Standard EP equipment cannot be used anymore, since it is only designed for low pacing voltages and does not provide sufficient voltages to deliver the pacing current through the highly resistive wires. Furthermore, higher voltages may overload an EP mapping input. In addition, one has to take precautions to ensure patient safety.

Currents applied to stimulate the heart of a patient in EP interventions are usually of the order of 10 mA. Voltages required to achieve such currents are mainly determined by a tissue impedance at a tip of a catheter employed to perform an EP intervention. The tissue impedance typically amounts to some hundred ohms. Thus, standard EP equipment provides output voltages of about 10 V.

The situation changes if highly resistive leads such as wires are used inside a catheter to prevent RF heating during use in MR systems, i.e. to provide RF-safety. In this case, the required voltage is mainly determined by the resistance of the leads, which significantly exceeds the tissue resistance. Thus, much higher voltages are needed, which cannot be provided by typical EP stimulators of EP equipment. Further, an additional problem can arise from these higher voltages. As the mapping input of the EP equipment is optimized for small signals, the measured IECG can be corrupted for a certain time after application of high voltage pacing pulses.

### SUMMARY OF THE INVENTION

It is an object of the present invention to enable safe EP interventions under MR guidance.

This object can be achieved by a device according to claim 1 and a method according to claim 14.

Accordingly, in a first aspect of the present invention a device is presented. The device can comprise a first interface connectable to a signal transmission/reception device configured to transmit and/or receive signals, a second interface connectable to a proximal side of a catheter configured to communicate signals between its proximal side and its distal side, a first sensor configured to sense a signal input via the first interface, and an adjustment unit configured to adjust the signal sensed by the first sensor and to output the adjusted signal via the second interface. The device enables pacing via a highly resistive conductor with a signal transmission/reception device such as e.g. standard EP equipment. That is, a desired stimulation may be achieved despite of the highly resistive conductor. Thus, when using a catheter containing such a conductor, EP interventions can be performed under MR guidance without major changes in the EP equipment. That is, an amplifier/interface for interfacing EP equipment and a catheter may be provided, which enables cardiac stimulation via highly resistive wires using standard EP equipment. Hence, MR-EP interventions become feasible with minimal modification of an existing clinical setup.

In a second aspect of the present invention the adjustment unit may comprise a linear amplifier configured to amplify the signal sensed by the first sensor. A gain of the linear amplifier can be given by a ratio of a resistance of the first sensor and a resistance of the catheter. Thus, pacing via a highly resistive conductor using standard EP equipment may be enabled by a quite simple arrangement.

In a third aspect of the present invention based on the second aspect the resistance of the catheter may be a resistance of a conductor of the catheter. The conductor can be made from a highly resistive material, and the linear amplifier may provide an appropriate amplification to achieve a pacing signal required with this material.

In a fourth aspect of the present invention the device can further comprise a second sensor configured to sense a signal communicated by the catheter, and the adjustment unit may comprise a controlled signal source configured to provide a signal based on the signal sensed by the first sensor and the signal sensed by the second sensor. This enables a signal adjustment irrespective of involved resistances. Thus, even if a resistance at the tip of the catheter is not negligible in comparison to the catheter resistance, an appropriate signal adjustment can be achieved.

In a fifth aspect of the present invention the device can further comprise a switching unit configured to switch between different switching states. In a first switching state the adjusted signal may be output via the second interface and communicated from the proximal side of the catheter to the distal side of the catheter. In a second switching state a signal detected on the distal side of the catheter can be communicated from the distal side of the catheter to the proximal side of the catheter, input via the second interface and output via the first interface. The switching unit may disconnect the catheter from an input of the signal transmission/reception device during signal transmission via an output thereof. For example, if the signal transmission/reception device is EP equipment, the catheter can be disconnected from a mapping input of the EP equipment during pacing, so that high voltage pacing pulses do not overload the mapping input. In this way, saturation of the mapping input may be avoided.

In a sixth aspect of the present invention based on the fifth aspect the first interface may comprise first and second terminals, and the switching unit can be configured to sense a signal at the first terminals, to switch to the first switching state if the signal is sensed at the first terminals, and to switch to the second switching state if the signal is not sensed at the first terminals. The first terminals may be used during pacing, the second terminals can be used during mapping, and switching from mapping to pacing may be triggered if a pacing pulse is detected at the first terminals.

In a seventh aspect of the present invention based on the fifth aspect the switching unit may be configured to sense a signal at the first interface, to switch to the first switching state if a value of the signal sensed at the first interface is equal to or above a certain value, and to switch to the second switching state if the value of the signal sensed at the first interface is below the certain value. This configuration enables to utilize the same terminals for mapping and pacing, wherein switching between these two modes can be triggered by a signal level at these terminals, which is higher for pacing in comparison with mapping.

In an eighth aspect of the present invention the device can further comprise an adjustable resistor configured to adapt an input resistance of the first interface, and a feedback controller configured to determine a resistance between electrodes of the catheter and to adjust the adjustable resistor based on the determined resistance. The adjustable resistor may be used to mimic an impedance at the tip of the catheter, so that the signal transmission/reception device does not “see” a highly resistive conductor of the catheter and can operate normally.

In a ninth aspect of the present invention the device may further comprise a second sensor configured to sense a signal at a first terminal of the second interface, a third sensor configured to sense a signal at a second terminal of the second interface, and a monitoring unit configured to compare signal values provided by the second and third sensors and to prevent the output of the adjusted signal via the second interface if a mismatch between the compared signal values is detected. The sensors can sense a signal input to the catheter and a signal output from the catheter. By comparing resulting signal values, the monitoring unit may determine whether the signal really flows through the catheter tip. If this is not the case, the output of the adjusted signal via the second interface can be prevented e.g. by disabling the adjustment unit. In this way, a patient can be safeguarded from excessive signal levels. For example, it may be prevented that the patient is harmed by high pacing voltages in case of a catheter malfunction.

In a tenth aspect of the present invention based on the ninth aspect the monitoring unit can be configured to compare the signal values provided by the second and third sensors as well as a signal value provided by a fourth sensor located on the distal side of the catheter and configured to sense a signal passing through the distal side of the catheter. The fourth sensor may serve as an additional observation point enabling an even more reliable detection of a catheter malfunction.

In an eleventh aspect of the present invention the signal input via the first interface may be a pacing signal and a signal output via the first interface can be a physiological signal, in particular an electrocardiogram signal. That is, the device can be used in combination with EP equipment inputting and outputting such kinds of signals.

In a twelfth aspect of the present invention the signal transmission/reception device may comprise an electrophysiologic recorder/stimulator, and the catheter can comprise a highly resistive conductor. That is, the device may be employed to interface an EP recorder/stimulator and a catheter comprising a highly resistive conductor suitable for EP interventions under MR guidance.

In a thirteenth aspect of the present invention an apparatus is presented. The apparatus may comprise a device according to the first aspect and a signal transmission/reception device, wherein the first interface can be an internal connection between the devices. Thus, an apparatus such as e.g. a dedicated MR-EP recorder/stimulator providing the functionality and advantages of the device according to the first aspect can be implemented.

In a fourteenth aspect of the present invention a method of operating a device comprising a first interface connectable to a signal transmission/reception device configured to transmit and/or receive signals and a second interface connectable to a proximal side of a catheter configured to communicate signals between its proximal side and its distal side is presented. The method can comprise sensing a signal input via the first interface, adjusting the signal sensed in the sensing step, and outputting the adjusted signal via the second interface. The method enables pacing via a highly resistive conductor with a signal transmission/reception device such as e.g. standard EP equipment. That is, a desired stimulation may be achieved despite of the highly resistive conductor. Thus, when using a catheter containing such a conductor, EP interventions can be performed under MR guidance without major changes in the EP equipment. That is, cardiac stimulation via highly resistive wires using standard EP equipment may be enabled. Thus, EP interventions can be performed under MR guidance without major changes in the EP equipment. Hence, MR-EP interventions become feasible with minimal modification of an existing clinical setup.

In a fifteenth aspect of the present invention a computer program is presented. The computer program may comprise program code means for causing a computer to carry out the steps of a method according to the fourteenth aspect when the computer program is carried out on a computer. Thus, the same advantages as with the method according to the fourteenth aspect can be achieved.

Further advantageous modifications are defined in the dependent claims.

### BRIEF DESCRIPTION OF THE DRAWINGS

These and other aspects of the present invention will be apparent from and elucidated by embodiments described hereinafter, by way of example, with reference to the accompanying drawings, in which:

FIG. 1 shows a schematic block diagram illustrating an exemplary arrangement of a device according to a first embodiment, in combination with a signal transmission/reception device and a catheter;

FIG. 2 shows a schematic circuit diagram illustrating a possible implementation of the exemplary device according to the first embodiment;

FIG. 3 shows a schematic block diagram illustrating an exemplary arrangement of a device according to a second embodiment, in combination with a signal transmission/reception device and a catheter;

FIG. 4 shows a schematic block diagram illustrating an exemplary arrangement of a device according to a third embodiment, in combination with a signal transmission/reception device and a catheter;

FIG. 5 shows a schematic circuit diagram illustrating a possible implementation of the exemplary device according to the third embodiment;

FIG. 6 shows a schematic block diagram illustrating an exemplary arrangement of a device according to a fourth embodiment, in combination with a signal transmission/reception device and a catheter;

FIG. 7 shows a schematic block diagram illustrating an exemplary arrangement of a device according to a fifth embodiment, in combination with a signal transmission/reception device and a catheter;

FIG. 8 shows a schematic block diagram illustrating an exemplary arrangement of a device according to a sixth embodiment, in combination with a signal transmission/reception device and a catheter;

FIG. 9 shows a schematic block diagram illustrating an exemplary arrangement of a device according to a seventh embodiment, in combination with a signal transmission/reception device and a catheter;

FIG. 10 shows a schematic block diagram illustrating an exemplary arrangement of an apparatus according to the embodiments;

FIG. 11 shows a flowchart illustrating basic steps of an exemplary method according to the embodiments; and

FIG. 12 shows an example of a software-based implementation of the embodiments.

### DETAILED DESCRIPTION OF EMBODIMENTS

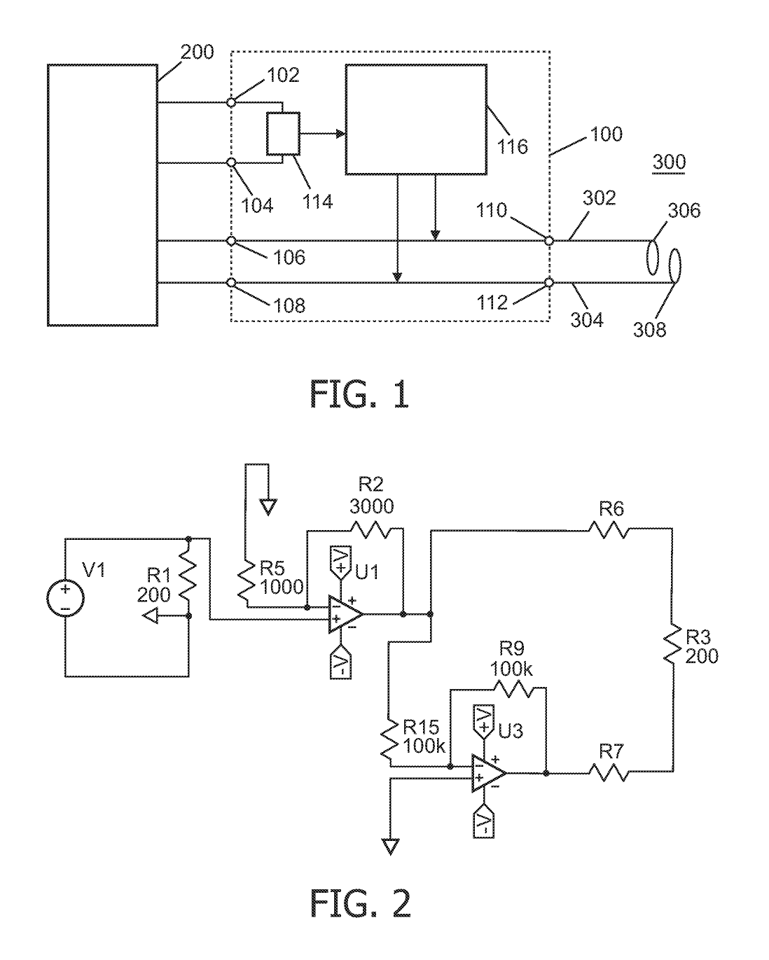

FIG. 1 shows a schematic block diagram illustrating an exemplary arrangement of a device 100 according to a first embodiment, in combination with a signal transmission/reception device 200 and a catheter 300.

The device 100 can comprise a first interface including first terminals 102, 104 and second terminals 106, 108, and a second interface including a first terminal 110 and a second terminal 112. It may further comprise a first sensing unit or sensor 114 such as e.g. a resistor, and an adjustment unit 116 such as e.g. an amplifier, for example a linear amplifier.

The signal transmission/reception device 200 can transmit signals via an output and receive signals via an input. It may be e.g. electrophysiologic (EP) equipment such as an EP recorder/stimulator. In this case, it can transmit pacing signals or currents for stimulating a patient's heart and/or receive mapping signals or currents. The output of the signal transmission/reception device 200 may be connected to the first terminals 102, 104 of the device 100, and the input thereof can be connected to the second terminals 106, 108 of the device 100. For example, a separate stimulator output or pacing output of an EP recorder/stimulator may be connected to the first terminals 102, 104, and a separate recorder input or mapping input thereof can be connected to the second terminals 106, 108.

The catheter 300 may comprise a conductor including first and second wires or leads 302, 304, and first and second electrodes 306, 308, i.e. an electrode pair. The first lead 302 can be connected to the first electrode 306, and the second lead 304 may be connected to the second electrode 308. Each of the first and second leads 302, 304 can be a highly resistive lead, to enable safe EP interventions under magnetic resonance (MR) guidance. A proximal side of the catheter 300 may be connected to the second interface, i.e. the first and second terminals 110, 112 of the second interface. Signals can be communicated between the proximal side and a distal side of the catheter 300, i.e. from the proximal side to the distal side and vice versa.

In a first operation mode, a signal transmitted by the signal transmission/reception device 200, such as e.g. a pacing signal or pacing current, may be input to the device 100 via the first interface. The first sensor 114 can sense the input signal and may be e.g. a resistor having a resistance in the order of a resistance of tissue at the tip of the catheter 300, such as e.g. tissue of a patient's heart. To compensate for a resistance loss caused by the highly resistive leads 302, 304 (i.e. the conductor of the catheter 300), the signal input via the first interface and sensed by the first sensor 114 can be adjusted by the adjustment unit 116. For example, an applied voltage may be amplified accordingly. A gain of the adjustment unit 116 can be given by a ratio of the resistance of the first sensor 114 and a resistance of the catheter 300. More specifically, it may be given by the ratio of the resistance of the first sensor 114 and a resistance of the conductor, i.e. a resistance of the leads 302, 304. Thus, the adjustment unit 116 can be a linear amplifier, so that a rather simple circuit configuration may be employed. The adjusted signal from the adjustment unit 116 can be output via the second interface and supplied to the catheter 300. The adjusted signal can be communicated by the leads 302, 304 to the electrodes 306, 308. For example, an appropriate pacing current may be conducted to the electrodes 306, 308, where it can be used to stimulate a patient's heart, i.e. to perform a pacing procedure.

In a second operation mode, a signal such as e.g. a physiological signal may be sensed by the electrodes 306, 308. Such signal detected on the distal side of the catheter 300 can be communicated from the distal side to the proximal side. Then, it can be input to the device 100 via the second interface and output via the first interface, i.e. input via the first and second terminals 110, 112 of the second interface and output via the second terminals 106, 108 of the first interface. Finally, the signal may be received by the signal transmission/reception device 200. For example, a mapping signal can be sensed by the electrodes 306, 308 at a patient's heart and supplied to the signal transmission/reception device 200, so that the intracardiac electrocardiogram (IECG) may be monitored during an EP procedure.

The above described device 100 represents some kind of interface box that measures, amplifies and transmits a signal from a separate output of the signal transmission/reception device 200 such as e.g. a separate EP stimulator output to the catheter 300. It enables to compensate for a voltage loss at the highly resistive leads 302, 304 of the catheter 300 and to provide a sufficient current flow at the electrodes 306, 308.

The device 100 according to the first embodiment performs a linear amplification, which works well if the tissue resistance at the tip of the catheter 300 is negligible compared to the catheter resistance, i.e. the resistance of the leads 302, 304. However, even if this does not apply, there are other solutions as described in connection with further embodiments below.

FIG. 2 shows a schematic circuit diagram illustrating a possible implementation of the exemplary device 100 according to the first embodiment. A resistor R1 corresponds to the first sensor 114, an amplifier circuit composed of two operational amplifiers U1, U3 and associated resistors R2, R5, R9 and R15 corresponds to the adjustment unit 116, a resistor R6 represents the resistance of the lead 302, a resistor R7 represents the resistance of the lead 304, and a resistor R3 represents the resistance between the electrodes 306, 308, i.e. a tissue resistance at the tip of the catheter 300.

The first and second interfaces of the device 100 are not illustrated in FIG. 2. However, the first terminals 102, 104 of the first interface would be located between a voltage source V1 and the resistor R1, while the connections between the catheter 300 and the signal transmission/reception device 200 (i.e. the connections between the first and second terminals 110, 112 of the second interface and the second terminals 106, 108 of the first interface) would extend from junctions located before the resistor R6 and the resistor R7, respectively.

If the signal transmission/reception device 200 is an EP recorder/stimulator, the current of the stimulator can be sensed at the resistor R1, and the amplification may be performed by the two operational amplifiers U1, U3. These can compensate for the voltage loss at the highly resistive leads 302, 304 of the catheter 300 as represented by the resistors R6, R7. Thus, a sufficient current may flow through the electrodes 306, 308 represented by the resistor R3, despite the highly resistive leads 302, 304.

In FIG. 2 some exemplary resistance values of the depicted resistors are indicated, i.e. 200Ω for the resistor R1, 3000Ω for the resistor R2, 200Ω for the resistor R3, 1000Ω for the resistor R5, and 100Ω for each of the resistors R9, R15. However, the circuit illustrated in FIG. 2 represents just one example of implementing the exemplary device 100 according to the first embodiment. As a matter of course, the device 100 can be implemented by alternative circuits.

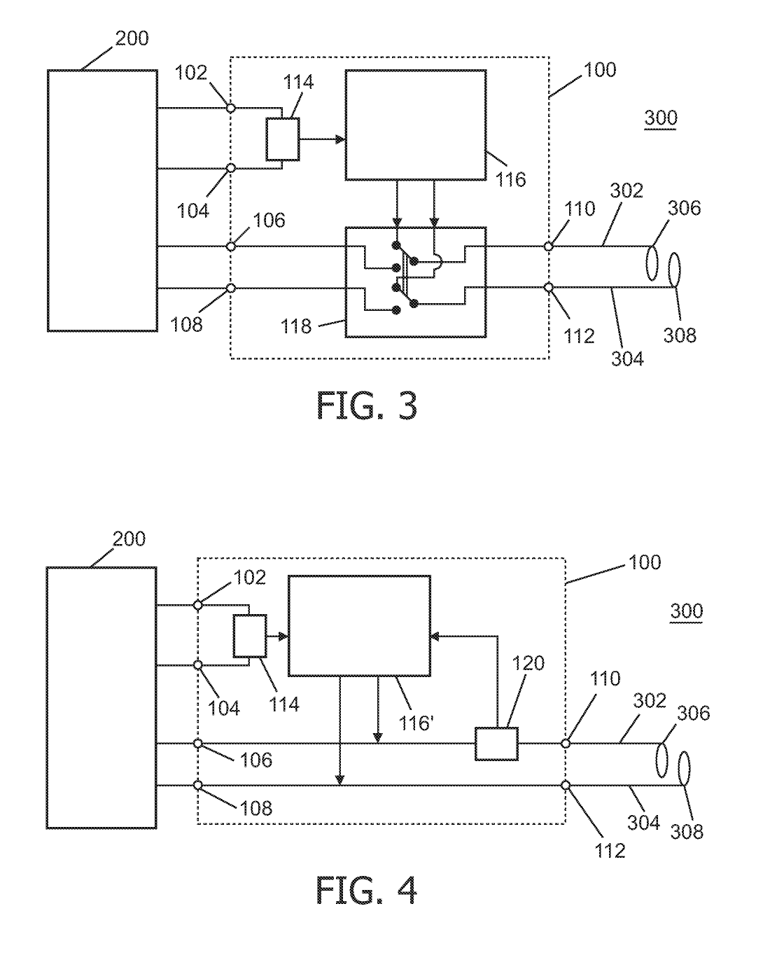

FIG. 3 shows a schematic block diagram illustrating an exemplary arrangement of a device 100 according to a second embodiment, in combination with a signal transmission/reception device 200 and a catheter 300.

The device 100 can comprise a first interface including first terminals 102, 104 and second terminals 106, 108, and a second interface including a first terminal 110 and a second terminal 112. It may further comprise a first sensing unit or sensor 114, and an adjustment unit 116. These components of the device 100 according to the second embodiment correspond to the components denoted by the same reference numerals as shown in FIG. 1 and described with reference to the same. Thus, a detailed description thereof is omitted. The device 100 can further comprise a switch or switching unit 118 that may be implemented by e.g. fast reed relays and is described in more detail below.

The signal transmission/reception device 200 as well as the catheter 300, its leads 302, 304 and its electrodes 306, 308 correspond to those elements denoted by the same reference numerals as shown in FIG. 1 and described with reference to the same. Thus, a detailed description thereof is omitted.

The switching unit 118 can switch between different switching states. In a first switching state the adjusted signal from the adjustment unit 116 can be output via the second interface of the device 100 (i.e. the first and second terminals 110, 112 of the second interface), supplied to the catheter 300 and communicated by the leads 302, 304 to the electrodes 306, 308, i.e. to the distal side of the catheter 300. In a second switching state a signal sensed by the electrodes 306, 308 (i.e. detected on the distal side of the catheter 300) may be communicated from the distal side to the proximal side of the catheter 300, input via the second interface of the device 100 (i.e. the first and second terminals 110, 112 of the second interface) and output via the first interface of the device 100 (i.e. the second terminals 106, 108 of the first interface).

The switching unit 118 can sense a signal at the first terminals 102, 104. It may switch to the first switching state if it senses the signal at the first terminals 102, 104 and switch to the second switching state if it does not sense the signal at the first terminals 102, 104.

The switching unit 118 can be used to disconnect the catheter 300 from the second terminals 106, 108 of the first interface and, thus, from the input of the signal transmission/reception device 200. In this way, it may be avoided that the signal transmission/reception device 200 receives a signal during a transmission procedure. Thus, the input of the signal transmission/reception device 200 can be protected.

If the signal transmission/reception device 200 is an EP recorder/stimulator, the first terminals 102, 104 may be used for a stimulation connection, and the second terminals 106, 108 may be used for a mapping connection. That is, separate stimulation and mapping connectors can be employed. In this case, the mapping connector can be switched off if a current at the stimulation connector is sensed. In this way, the mapping input can be disconnected from the catheter 300 during pacing. Thus, overloading of the mapping input by high pacing voltages required due to the highly resistive leads 302, 304 may be prevented. Thus, the mapping input can be protected during pacing.

FIG. 4 shows a schematic block diagram illustrating an exemplary arrangement of a device 100 according to a third embodiment, in combination with a signal transmission/reception device 200 and a catheter 300.

The device 100 can comprise a first interface including first terminals 102, 104 and second terminals 106, 108, and a second interface including a first terminal 110 and a second terminal 112. It may further comprise a first sensing unit or sensor 114. These components of the device 100 according to the third embodiment correspond to the components denoted by the same reference numerals as shown in FIG. 1 and described with reference to the same. Thus, a detailed description thereof is omitted. The device 100 can further comprise an adjustment unit 116′ different from the adjustment unit 116 shown in FIG. 1 as well as a second sensing unit or sensor 120 such as e.g. a resistor. These components are described in more detail below.

The signal transmission/reception device 200 as well as the catheter 300, its leads 302, 304 and its electrodes 306, 308 correspond to those elements denoted by the same reference numerals as shown in FIG. 1 and described with reference to the same. Thus, a detailed description thereof is omitted.

The second sensor 120 can sense a signal communicated by the catheter 300. For example, it may sense a pacing signal or pacing current supplied via the first terminal 110 of the second interface to the catheter 300, if the signal transmission/reception device 200 is an EP recorder/stimulator.

The adjustment unit 116′ can be composed of or comprise a controlled signal source such as e.g. a controlled current source. It may provide a signal based on the signal sensed by the first sensor 114 and the signal sensed by the second sensor 120, so that the signals sensed by these two sensors can be equal. That is, a signal in the catheter 300 may be monitored and set to a desired value that is sensed at the first terminals 102, 104 of the first interface. This can ensure that the desired signal value, for example a selected pacing current, may be applied independently of resistances involved.

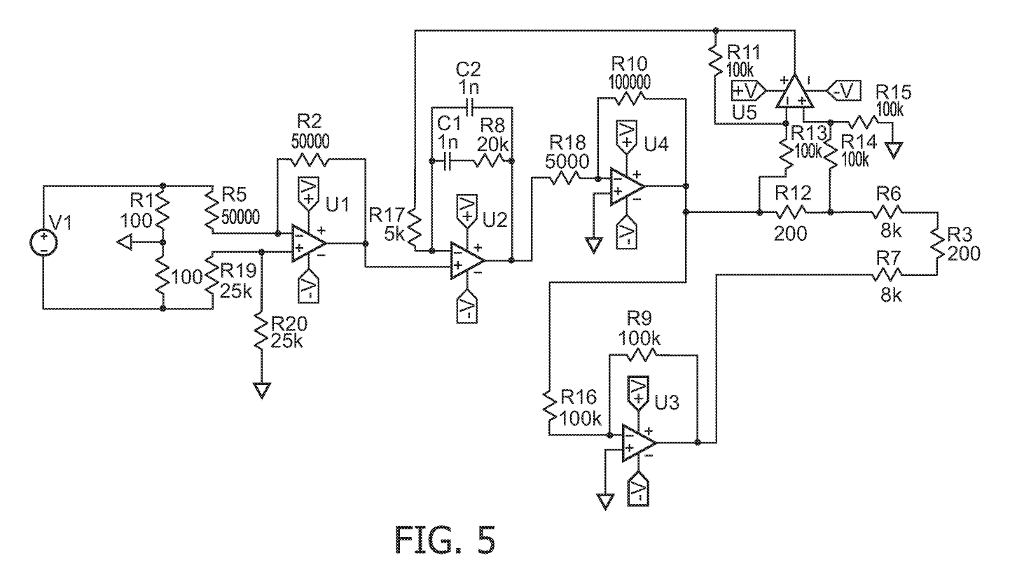

FIG. 5 shows a schematic circuit diagram illustrating a possible implementation of the exemplary device 100 according to the third embodiment. A resistor R1 and an amplifier circuit for measuring a voltage drop at the resistor R1 correspond to the first sensor 114. This differential amplifier circuit can comprise an operational amplifier U1 as well as resistors R2, R5, R19 and R20 associated with the operational amplifier U1. A resistor R12 and an amplifier circuit for measuring a voltage drop at the resistor R12 correspond to the second sensor 120. This differential amplifier circuit may comprise an operational amplifier U5 as well as resistors R11, R13, R14 and R15 associated with the operational amplifier U5. A circuit composed of an operational amplifier U3 with associated resistors R9, R16, an operational amplifier U4 with associated resistors R10, R18 as well as a controller U2 with associated resistors R8, R17 and capacitors C1, C2 corresponds to the adjustment unit 116′. A resistor R6 represents the resistance of the lead 302, a resistor R7 represents the resistance of the lead 304, and a resistor R3 represents the resistance between the electrodes 306, 308, i.e. a tissue resistance at the tip of the catheter 300.

The first and second interfaces of the device 100 are not illustrated in FIG. 5. However, the first terminals 102, 104 of the first interface would be located between a voltage source V1 and the resistor R1, while the connections between the catheter 300 and the signal transmission/reception device 200 (i.e. the connections between the first and second terminals 110, 112 of the second interface and the second terminals 106, 108 of the first interface) would extend from junctions located before the resistor R6 and the resistor R7, respectively.

The controller U2 can compare two reference signals sensed by the resistors R1, R12 and control an amplifier circuit accordingly. The amplifier circuit may be composed of the operational amplifier U3 and the resistors R9, R16 associated therewith as well as the operational amplifier U4 and the resistors R10, R18 associated therewith. If the signal transmission/reception device 200 is an EP recorder/stimulator, the current at the stimulator output can be sensed at the resistor R1, and the current through the catheter 300 may be sensed at the resistor R12. Then, the current through the catheter 300 can be adjusted to that at the stimulator output. Thus, the voltage is not linearly amplified, but the current through the catheter is measured at R12 and adjusted to the same value as the original stimulator output current measured at R1. Hence, it is possible to compensate for the voltage loss at the highly resistive leads 302, 304 of the catheter 300 as represented by the resistors R6, R7. Thus, a sufficient current may flow through the electrodes 306, 308 represented by the resistor R3, despite the highly resistive leads. This can be achieved independently of resistances involved.

In FIG. 5 some exemplary resistance values of the depicted resistors are indicated, i.e. 2×100Ω for the resistor R1, 50Ω for the resistor R2, 200Ω for the resistor R3, 50 kΩ for the resistor R5, 8 kΩ for each of the resistors R6, R7, 20 kΩ for the resistor R8, 100 kΩ for each of the resistors R9, R10, R11, 200Ω for the resistor R12, 100 kΩ for each of the resistors R13, R14, R15, R16, 5 kΩ for each of the resistors R17, R18, and 25 kΩ for each of the resistors R19, R20. Further, some exemplary capacitance values of the depicted capacitors are indicated, i.e. 1 nF for each of the capacitors C1, C2. However, the circuit illustrated in FIG. 5 represents just one example of implementing the exemplary device 100 according to the third embodiment. As a matter of course, the device 100 can be implemented by alternative circuits.

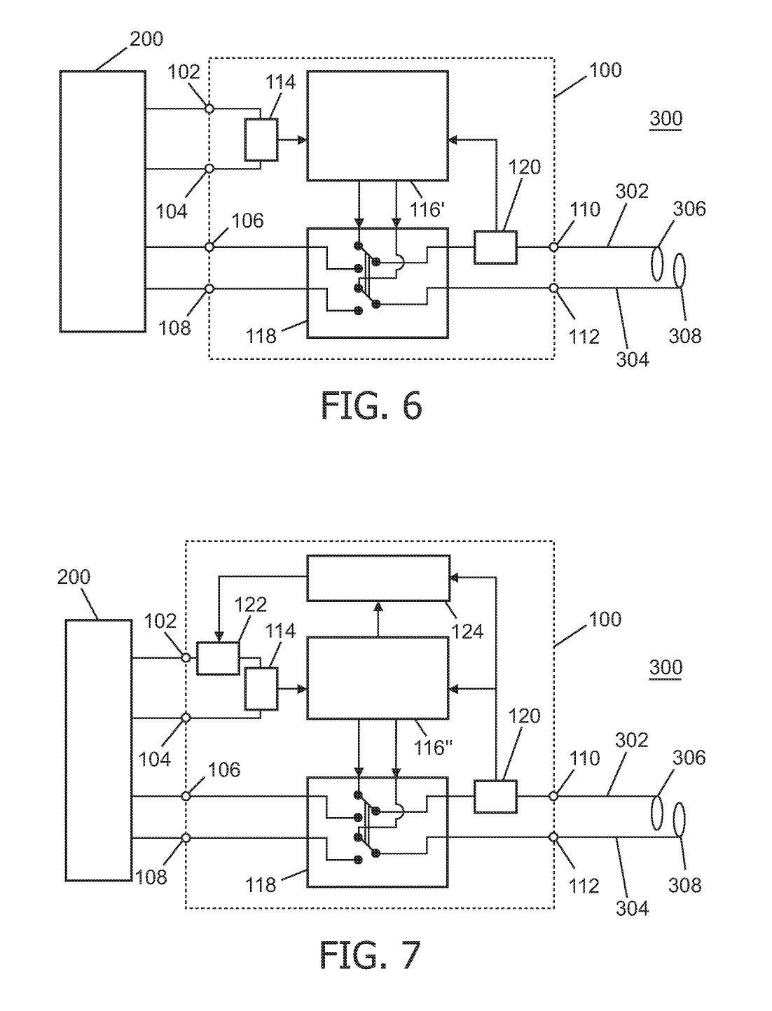

FIG. 6 shows a schematic block diagram illustrating an exemplary arrangement of a device 100 according to a fourth embodiment, in combination with a signal transmission/reception device 200 and a catheter 300.

The device 100 can comprise a first interface including first terminals 102, 104 and second terminals 106, 108, and a second interface including a first terminal 110 and a second terminal 112. It may further comprise a first sensing unit or sensor 114. These components of the device 100 according to the fourth embodiment correspond to the components denoted by the same reference numerals as shown in FIG. 1 and described with reference to the same. Thus, a detailed description thereof is omitted. The device 100 can further comprise an adjustment unit 116′, a switching unit 118, and a second sensing unit or sensor 120. These components correspond to the components denoted by the same reference numerals as shown in FIGS. 3, 4 and described with reference to the same. Hence, a detailed description thereof is omitted.

The signal transmission/reception device 200 as well as the catheter 300, its leads 302, 304 and its electrodes 306, 308 correspond to those elements denoted by the same reference numerals as shown in FIG. 1 and described with reference to the same. Thus, a detailed description thereof is omitted.

The device 100 according to the fourth embodiment combines the functionalities and advantages of the devices according to the second and third embodiments. On the one hand, a signal in the catheter 300 may be monitored and set to a desired value that is sensed at the first terminals 102, 104 of the first interface. It can be ensured that the desired signal value such as e.g. a selected pacing current may be applied independently of resistances involved. On the other hand, the catheter 300 may be disconnected from the second terminals 106, 108 of the first interface and, thus, from the input of the signal transmission/reception device 200. In this way, it can be avoided that the signal transmission/reception device 200 receives a signal during a transmission procedure. Thus, the input of the signal transmission/reception device 200 may be protected.

FIG. 7 shows a schematic block diagram illustrating an exemplary arrangement of a device 100 according to a fifth embodiment, in combination with a signal transmission/reception device 200 and a catheter 300.

The device 100 can comprise a first interface including first terminals 102, 104 and second terminals 106, 108, and a second interface including a first terminal 110 and a second terminal 112. It may further comprise a first sensing unit or sensor 114. These components of the device 100 according to the fifth embodiment correspond to the components denoted by the same reference numerals as shown in FIG. 1 and described with reference to the same. Thus, a detailed description thereof is omitted. The device 100 can further comprise a switching unit 118 and a second sensing unit or sensor 120. These components correspond to the components denoted by the same reference numerals as shown in FIGS. 3, 4 and described with reference to the same. Hence, a detailed description thereof is omitted. In addition, the device 100 may comprise an adjustment unit 116″ similar to the adjustment unit 116′ as shown in FIG. 4 and described with reference to the same, and an adjustable resistor 122 and a feedback controller 124.

The signal transmission/reception device 200 as well as the catheter 300, its leads 302, 304 and its electrodes 306, 308 correspond to those elements denoted by the same reference numerals as shown in FIG. 1 and described with reference to the same. Thus, a detailed description thereof is omitted.

The adjustment unit 116″ can provide the same functionality as the adjustment unit 116′, except for additionally supplying some input to the feedback controller 124 as illustrated by an arrow in FIG. 7.

The adjustable resistor 122 may be used to adapt an input resistance of the first interface such that a resistance between the electrodes 306, 308 of the catheter 300 is mimicked. It can be implemented e.g. by a transistor.

The feedback controller 124 can determine a resistance between the electrodes 306, 308 of the catheter and adjust the adjustable resistor 122 based on the determined resistance. The resistance between the electrodes 306, 308 may be easily calculated if the applied voltage and the current are measured and the resistance of the leads 302, 304 inside the catheter 300 is known. Then, the adjustable resistor 122 can be adjusted such that it mimics the load at the tip of the catheter 300. In this way, the real resistance between the electrodes 306, 308 may be “seen” at the first terminals 102, 104 of the first interface, although highly resistive leads 302, 304 are used in the catheter 300.

If the signal transmission/reception device 200 is an EP recorder/stimulator, a resistance feedback to the EP stimulator can be implemented by the above features. EP stimulators generally also monitor the resistance of the catheter, so that they may provide a warning to an operator if there is a short circuit (resistance too low) or if the catheter is not correctly connected (resistance too high). When using a catheter comprising highly resistive leads, the monitoring would not function correctly, since the EP stimulator would not “see” the real resistance at the catheter tip. However, as described above, it is possible to adjust the adjustable resistor 122 such that it mimics the load at the tip of the catheter 300. In this way, the EP stimulator will still “see” the real resistance between the electrodes 306, 308 (e.g. a real tissue impedance), although highly resistive leads 302, 304 are used. Thus, the basic safety warnings of the EP recorder/stimulator remain functional.

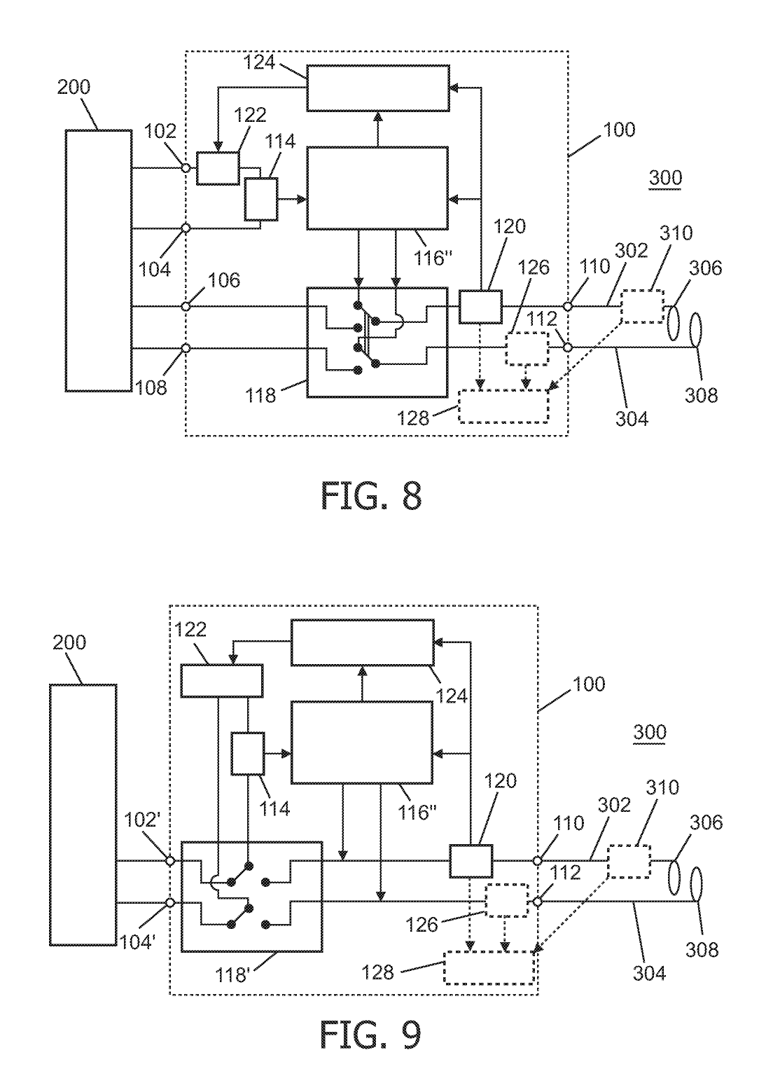

FIG. 8 shows a schematic block diagram illustrating an exemplary arrangement of a device 100 according to a sixth embodiment, in combination with a signal transmission/reception device 200 and a catheter 300.

The device 100 can comprise a first interface including first terminals 102, 104 and second terminals 106, 108, and a second interface including a first terminal 110 and a second terminal 112. It may further comprise a first sensing unit or sensor 114, an adjustment unit 116″, a switching unit 118, a second sensing unit or sensor 120, an adjustable resistor 122, and a feedback controller 124. These components of the device 100 according to the sixth embodiment correspond to the components denoted by the same reference numerals as shown in FIGS. 1, 3, 4, 7 and described with reference to the same. Thus, a detailed description thereof is omitted. In addition, the device 100 can comprise a third sensing unit or sensor 126 such as e.g. a resistor, and a monitoring unit 128.

The signal transmission/reception device 200 as well as the catheter 300, its leads 302, 304 and its electrodes 306, 308 correspond to those elements denoted by the same reference numerals as shown in FIG. 1 and described with reference to the same. Thus, a detailed description thereof is omitted. However, the catheter 300 may comprise a fourth sensing unit or sensor 310 such as e.g. a resistor. The fourth sensor 310 can be located at the distal side of the catheter 300 and may be used to sense a signal passing through the distal side. For example, it may be located at the lead 302 and close to the electrode 306.

The third sensor 126 can be used to sense a signal at the second terminal 112 of the second interface. The monitoring unit 128 may compare signal values provided by the second sensor 120 and the third sensor 126 to determine whether there is a mismatch between these signal values. It can also compare these signal values and an additional signal value provided by the fourth sensor 310 located at the distal side of the catheter 300 to determine whether there is some mismatch. In this way, the measured signals at several observation points comprising all output connections of the device 100 and potentially also including distal parts of the catheter 300 may be compared.

If a mismatch between the compared signal values is detected by the monitoring unit 128, it can prevent the output of the adjusted signal via the second interface. For example, the power supply may be switched off.

The above described monitoring procedure can be used to ensure patient safety. When using highly resistive leads such as the leads 302, 304 inside an EP catheter, much higher voltages are required to achieve sufficient pacing currents. It has to be taken care that these voltages do not harm the patient in case of a malfunction. Monitoring the currents at the proximal and distal ends of the catheter 300 enables to verify that there is no insulation breakdown and the current really flows through the electrodes 306, 308 during pacing. If a mismatch between the currents is detected, the power supply may be switched off.

In addition to the above features, a current limiter that can be used to avoid an excessive current in case of short circuits inside the catheter 300 may be implemented in the device 100 as well. Such measure can help in ensuring patient safety.

FIG. 9 shows a schematic block diagram illustrating an exemplary arrangement of a device 100 according to a seventh embodiment, in combination with a signal transmission/reception device 200 and a catheter 300.

The device 100 can comprise a second interface including a first terminal 110 and a second terminal 112. It may further comprise a first sensing unit or sensor 114, an adjustment unit 116″, a second sensing unit or sensor 120, an adjustable resistor 122, a feedback controller 124, a third sensing unit or sensor 126, and a monitoring unit 128. These components of the device 100 according to the seventh embodiment correspond to the components denoted by the same reference numerals as shown in FIGS. 1, 4, 7, 8 and described with reference to the same. Thus, a detailed description thereof is omitted. In addition, the device 100 can comprise a first interface including first terminals 102′, 104′, and a switch or switching unit 118′ that may be implemented by e.g. fast reed relays.

The signal transmission/reception device 200 as well as the catheter 300, its leads 302, 304, its electrodes 306, 308 and its fourth sensing unit or sensor 310 correspond to those elements denoted by the same reference numerals as shown in FIGS. 1, 8 and described with reference to the same. Thus, a detailed description thereof is omitted.

With the device 100 according to the seventh embodiment, signal transmission and reception can be performed via the same terminals 102′, 104′ of the first interface. The switching unit 118′ can sense a signal at the first terminals 102′, 104′ and determine whether or not its value is equal to or above a certain value such as a predetermined value. If the value of the signal at the first terminals 102′, 104′ is equal to or above the certain value, the switching unit 118′ can switch to a first switching state enabling to supply a signal input via the first terminals 102′, 104′ to the first sensor 114 and output an adjusted signal from the adjustment unit 116″ via the second interface of the device 100 (i.e. the first and second terminals 110, 112 of the second interface). If the value of the signal at the first terminals 102′, 104′ is below the certain value, the switching unit 118′ can switch to a second switching state enabling to input a signal sensed by the electrodes 306, 308 (i.e. detected on the distal side of the catheter 300) via the second interface of the device 100 (i.e. the first and second terminals 110, 112 of the second interface) and to output it via the first interface of the device 100 (i.e. the first terminals 102′, 104′ of the first interface).

The switching unit 118′ can be used to disconnect the catheter 300 from the first terminals 102′, 104′ of the first interface and, thus, from the input of the signal transmission/reception device 200. In this way, it may be avoided that the signal transmission/reception device 200 receives a signal during a transmission procedure. Thus, the input of the signal transmission/reception device 200 can be protected.

If the signal transmission/reception device 200 is an EP recorder/stimulator, the first terminals 102′, 104′ may be used for a stimulation connection as well as a mapping connection. That is, stimulation and mapping can be performed by the same connector. The voltage at this connector may be monitored, and if it exceeds several mV (i.e. it is not an ECG signal, but a pacing pulse), the input signal can be directed to the first sensor 114 and the connection to the catheter 300 may be blocked. If the voltage disappears, the process can be reversed. That is, the connection to the first sensor 114 may be blocked and the connection to the catheter 300 can be reestablished. In this way, overloading of the mapping input of the EP recorder by high pacing voltages required due to the highly resistive leads 302, 304 may be prevented. Thus, the mapping input can be protected during pacing.

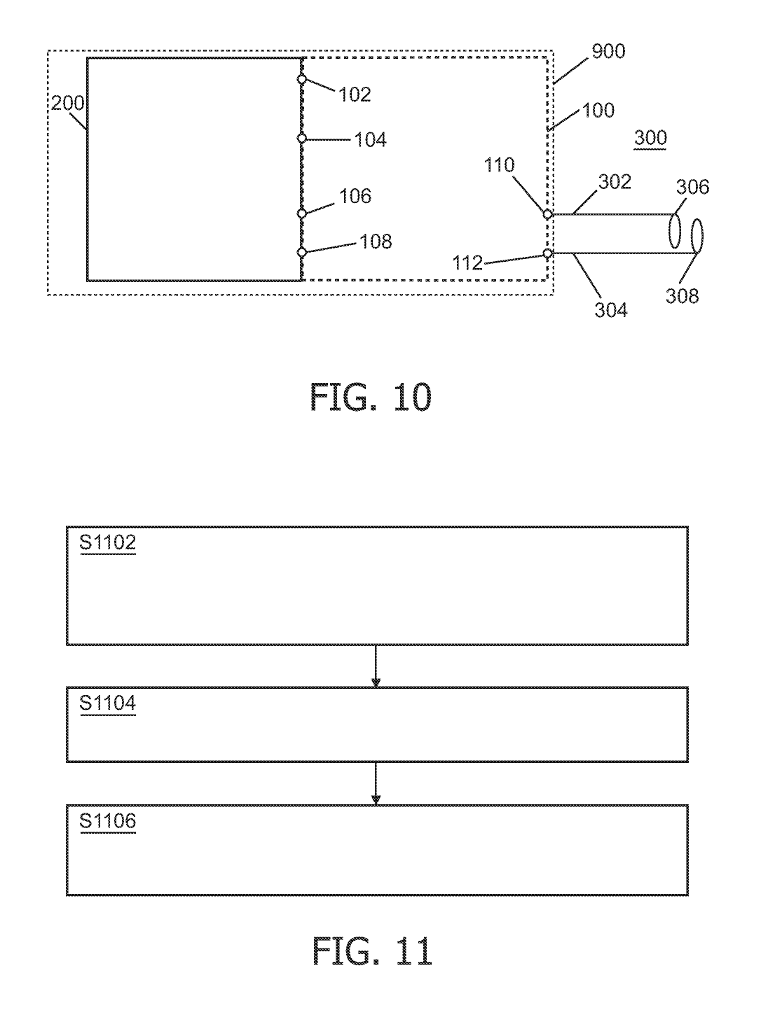

FIG. 10 shows a schematic block diagram illustrating an exemplary arrangement of an apparatus 900 according to the embodiments. The apparatus may comprise a device 100 and a signal transmission/reception device 200 according to one of the above described embodiments. In this case, the first interface can be an internal connection between the device 100 and the signal transmission/reception device 200. While first terminals 102, 104 and second terminals 106, 108 are depicted in FIG. 10, the first interface may also comprise only first terminals 102′, 104′. First and second terminals 110, 112 of the second interface can be connected to a catheter 300 according to the embodiments.

The apparatus 900 may provide the functionality and advantages of the device 100 according to any one of the above embodiments. It can be e.g. a dedicated MR-EP recorder/stimulator enabling EP interventions under MR guidance.

FIG. 11 shows a flowchart illustrating basic steps of an exemplary method according to the embodiments. The method can be a method of operating a device 100 comprising a first interface 102, 104, 106, 108 (102′, 104′) connectable to a signal transmission/reception device 200 configured to transmit and/or receive signals and a second interface 110, 112 connectable to a proximal side of a catheter 300 configured to communicate signals between its proximal side and its distal side. The method may comprise a step S1102 of sensing a signal input via the first interface, a step S1104 of adjusting the signal sensed in the sensing step, and a step S1106 of outputting the adjusted signal via the second interface.

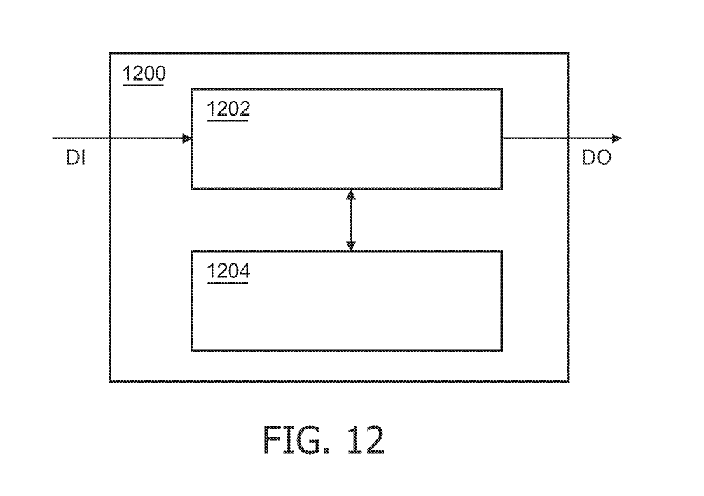

FIG. 12 shows an example of a software-based implementation of the embodiments. Here, a device 1200 can comprise a processing unit (PU) 1202, which may be provided on a single chip or a chip module and which can be any processor or computer device with a control unit that performs control based on software routines of a control program stored in a memory (MEM) 1204. Program code instructions may be fetched from the MEM 1204 and loaded into the control unit of the PU 1202 in order to perform processing steps such as those described in connection with FIG. 11. The processing steps can be performed on the basis of input data DI and may generate output data DO. The input data DI may represent e.g. an input signal such as a pacing signal supplied by a signal transmission/reception device, and the output data DO can represent e.g. an output signal such as an adjusted signal supplied to a catheter.

The device and method according to the above embodiments allow usage of standard EP equipment for MR-EP interventions with minimal modification of the existing clinical setup. Further, they provide additional features such as e.g. mimicking a tissue impedance at an output of the EP stimulator or safeguarding a patient from excessive voltages.

In summary, the present invention relates to a device 100 and method for interfacing a signal transmission/reception device 200 and a catheter 300. A signal transmitted by the signal transmission/reception device 200 and supplied to the device 100 via a first interface 102, 104, 106, 108 can be sensed by a first sensor 114. The sensed signal may be adjusted by an adjustment unit 116. The adjusted signal can be output via a second interface 110, 112 and supplied to the catheter 300. In this way, a resistance loss caused by a conductor 302, 304 of the catheter 300 may be compensated for.

While the present invention has been illustrated and described in detail in the drawings and foregoing description, such illustration and description are to be considered illustrative or exemplary and not restrictive. The invention is not limited to the disclosed embodiments. For example, while the first sensor 114 and the adjustable resistor 122 are depicted as separate components in FIGS. 7, 8 and 9 and described as such separate components with reference to the same, they can be integrated in a single component. For example, the first sensor 114 may be omitted, and the adjustable resistor 122 can provide its functionality. That is, the adjustable resistor 122 may be used for both of sensing a signal input via the first interface and adjusting the input resistance of the first interface. Further, features from different embodiments can be combined in other ways. For example, the switching unit 118′ described in connection with the seventh embodiment may be used in place of the switching unit 118 for a device 100 not comprising the third sensor 126 and the monitoring unit 128.

Moreover, the description and drawings relate to a single catheter comprising one electrode pair. As a matter of course, more than one catheter and more than one electrode pair, respectively, can be used simultaneously. In such a case, several devices 100 respectively associated with one of the catheters/electrode pairs may be employed. Alternatively, a device comprising a plurality of separate first interfaces that are independent of each other and a plurality of separate second interfaces that are independent of each other can be utilized to interface the more than one catheter/electrode pair.

Variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

A computer program capable of controlling a processor to perform the claimed features can be stored/distributed on a suitable medium, such as an optical storage medium or a solid-state medium supplied together with or as part of other hardware, but may also be distributed in other forms, such as via the Internet or other wired or wireless telecommunication systems. It can be used in conjunction with a new system, but may also be applied when updating or upgrading existing systems in order to enable them to perform the claimed features.

A computer program product for a computer can comprise software code portions for performing e.g. processing steps such as those described in connection with FIG. 11 when the computer program product is run on the computer. The computer program product may further comprise a computer-readable medium on which the software code portions are stored, such as e.g. an optical storage medium or a solid-state medium.

Any reference signs in the claims should not be construed as limiting the scope thereof.

1. Device (100) comprising:
a first interface (102, 104, 106, 108; 102′, 104′) connectable to a signal transmission/reception device (200) configured to transmit and/or receive signals;
a second interface (110, 112) connectable to a proximal side of a catheter (300) configured to communicate signals between its proximal side and its distal side;
a first sensor (114) configured to sense a signal input via said first interface; and
an adjustment unit (116; 116; 116″) configured to adjust said signal sensed by said first sensor, and to output said adjusted signal via said second interface.

2. Device according to claim 1,
wherein said adjustment unit comprises a linear amplifier (116) configured to amplify said signal sensed by said first sensor, and
wherein a gain of said linear amplifier is given by a ratio of a resistance of said first sensor and a resistance of said catheter.

3. Device according to claim 2,
wherein said resistance of said catheter is a resistance of a conductor (302, 304) of said catheter.

4. Device according to claim 1, comprising:
a second sensor (120) configured to sense a signal communicated by said catheter,
wherein said adjustment unit comprises a controlled signal source (116; 116″) configured to provide a signal based on said signal sensed by said first sensor and said signal sensed by said second sensor.

5. Device according to claim 1, comprising:
a switching unit (118; 118′) configured to switch between different switching states,
wherein in a first switching state said adjusted signal is output via said second interface and communicated from said proximal side of said catheter to said distal side of said catheter, and
wherein in a second switching state a signal detected on said distal side of said catheter is communicated from said distal side of said catheter to said proximal side of said catheter, input via said second interface and output via said first interface.

6. Device according to claim 5,
wherein said first interface comprises first and second terminals (102, 104, 106, 108), and
wherein said switching unit (118) is configured to sense a signal at said first terminals (102, 104), to switch to said first switching state if said signal is sensed at said first terminals, and to switch to said second switching state if said signal is not sensed at said first terminals.

7. Device according to claim 5,
wherein said switching unit (118′) is configured to sense a signal at said first interface (102′, 104′), to switch to said first switching state if a value of said signal sensed at said first interface is equal to or above a certain value, and to switch to said second switching state if said value of said signal sensed at said first interface is below said certain value.

8. Device according to claim 1, comprising:
an adjustable resistor (122) configured to adapt an input resistance of said first interface; and
a feedback controller (124) configured to determine a resistance between electrodes (306, 308) of said catheter, and to adjust said adjustable resistor based on said determined resistance.

9. Device according to claim 1, comprising:
a second sensor (120) configured to sense a signal at a first terminal (110) of said second interface;
a third sensor (126) configured to sense a signal at a second terminal (112) of said second interface; and
a monitoring unit (128) configured to compare signal values provided by said second and third sensors, and to prevent said output of said adjusted signal via said second interface if a mismatch between said compared signal values is detected.

10. Device according to claim 9,
wherein said monitoring unit is configured to compare said signal values provided by said second and third sensors as well as a signal value provided by a fourth sensor (310) located on said distal side of said catheter and configured to sense a signal passing through said distal side of said catheter.

11. Device according to claim 1,
wherein said signal input via said first interface is a pacing signal, and
wherein a signal output via said first interface is a physiological signal, in particular an electrocardiogram signal.

12. Device according to claim 1,
wherein said signal transmission/reception device comprises an electrophysiologic recorder/stimulator, and
wherein said catheter comprises a highly resistive conductor (302, 304).

13. Apparatus (900) comprising:
a device (100) according to claim 1; and
a signal transmission/reception device (200),
wherein said first interface (102, 104, 106, 108; 102′, 104′) is an internal connection between said devices (100, 200).

14. Method of operating a device (100) comprising a first interface (102, 104, 106, 108; 102′, 104′) connectable to a signal transmission/reception device (200) configured to transmit and/or receive signals and a second interface (110, 112) connectable to a proximal side of a catheter (300) configured to communicate signals between its proximal side and its distal side, said method comprising:
sensing a signal input via said first interface (S1102);
adjusting said signal sensed in said sensing step (S1104); and
outputting said adjusted signal via said second interface (S1106).

15. Computer program comprising program code means for causing a computer to carry out the steps of a method according to claim 14 when said computer program is carried out on a computer.
